(19) United States
(12) Patent Application Publication
(10) Pub. No.: US 2024/0032535 A1
(43) Pub. Date: Feb. 1, 2024

(54) ANTIMICROBIAL COMPOSITIONS AND METHODS WITH SUPRAMOLECULAR STRUCTURES

(71) Applicant: BPS JUST ENERGY TECHNOLOGY, LLC, Argyle, TX (US)

(72) Inventors: Robert A. GEIGER, Denton, TX (US); Donna SHOTWELL, Eufaula, OK (US)

(21) Appl. No.: 18/257,519

(22) PCT Filed: Dec. 14, 2021
(86) PCT No.: PCT/US21/63279

§ 371 Date: Jun. 14, 2023

Related U.S. Application Data
(60) Provisional application No. 63/125,131, filed on Dec. 14, 2020.

(51) Int. Cl. A01N 33/12; A01N 37/16; A01N 35/02; A01N 59/00; A01N 57/20; A01N 31/02; A01P 1/00; A01N 25/22

(52) U.S. Cl. CPC A01N 33/12; A01N 37/16; A01N 35/02; A01N 59/00; A01N 57/20; A01N 31/02; A01P 1/00; A01N 25/22

(57) ABSTRACT

Compositions with supramolecular structures for use in antimicrobial methods include an antimicrobial agent; a supramolecular host chemical or a supramolecular guest chemical configured to engage in host-guest chemistry with the antimicrobial agent; and a solvent. Methods of inhibiting the growth of microorganisms on a surface or in a fluid, or reducing the contact time of the composition with a surface to be disinfected include applying an antimicrobially effective amount of the composition to the surface or adding an antimicrobially effective amount of the composition to the fluid.

### FIELD OF THE INVENTION

The present disclosure relates to antimicrobial compositions that include a disinfectant, antiseptic, and/or a biocide having supramolecular structures that increase the biocidal activity of the disinfectant, antiseptic, and/or biocide, and methods of using the antimicrobial compositions to increase kill efficiency or decrease dwell or contact times of the disinfectant, antiseptic, and/or biocide.

### BACKGROUND OF THE DISCLOSURE

Antiseptics, biocides, and disinfectants are extensively used worldwide in a variety of applications to minimize exposure to harmful microorganisms, pathogens, or viruses. There has been mounting concerns over the potential for microbial contamination, and infection risks in the food and general consumer markets have also led to increased use of antiseptics and disinfectants by the public. With increased and repeated use of antiseptics and disinfectants, there has been a large concern with bacterial resistance. A wide assortment of active chemical agents are found in these products, and of the currently active chemicals that are utilized in this area, many have been used for hundreds of years, including alcohols, phenols, iodine, and chlorine.

Considerable progress has been made in understanding the mechanisms of the antimicrobial action of antiseptics, disinfectants, and biocides. There are typically two modes of action for disinfectants—growth inhibition and lethal action. The emphasis over the last few decades has been on the development of new active chemicals to increase kill efficiency or decrease dwell time. However, this developmental process takes considerable time and requires a lengthy regulatory process. Additional work has been made on utilizing different surfactants to increase spreadability of the chemical active across the surface being treated to decrease dwell time by increasing contact surface or surface penetration.

Even though these techniques overcome different and difficult situations, there has been a growing concern on increasing kill efficiency and/or decreasing dwell time with currently approved active chemicals.

Accordingly, improved compositions and methods are needed to boost the antimicrobial activity of currently approved disinfectants, antiseptics, and/or biocides.

### BRIEF DESCRIPTION OF THE DRAWINGS

The present disclosure is best understood from the following detailed description when read with the accompanying figures.

FIG. 1 is a graph showing the percent reduction in bacteria with the composition of Example 1 according to aspects of the present disclosure;

FIG. 2 is a graph showing the percent reduction in bacteria with the composition of Example 2 according to aspects of the present disclosure;

FIG. 3 is a graph showing the percent reduction in bacteria with the composition of Example 3 according to aspects of the present disclosure;

FIG. 4 is a graph showing the percent reduction in bacteria with the composition of Example 4 according to aspects of the present disclosure;

FIG. 5 is a graph showing the percent reduction in bacteria with the composition of Example 5 according to aspects of the present disclosure; and

FIG. 6 is a graph showing the percent reduction in bacteria with the composition of Example 6 according to aspects of the present disclosure.

### DETAILED DESCRIPTION OF THE PREFERRED EMBODIMENTS

The present disclosure is directed to antimicrobial compositions that increase kill efficiency or decrease the dwell or contact time of an antimicrobial agent, such as an antiseptic, a biocide, and a disinfectant, by the formation of supramolecular structures. As used herein, “antimicrobial” means, without limitation, anti-bacterial, anti-viral, anti-fungal, biocide, disinfectant, sanitizing, antiseptic, and/or mildewcidal.

In certain embodiments, the antimicrobial compositions include (1) an antimicrobial agent, such as an antiseptic, a biocide, and/or a disinfectant; (2) a supramolecular host or guest chemical configured to engage in host-guest chemistry with the antimicrobial agent; and (3) a solvent, such as water or an alcohol. In some embodiments, formulation additives, such as pH buffers, colorants, adjuvants, stabilizers, or rheology modifiers are included in the antimicrobial composition, and any suitable type and amount of each, in any combination, may be used in the present antimicrobial compositions based on the guidance provided herein. Suitable pH buffers or neutralizers include citric acid, phosphate buffers, sodium hydroxide, and hydrochloric acid. Any kind of dye or pigment may serve as the colorant. Suitable adjuvants include all kinds of surfactants that are used to spread, stick onto, or penetrate different types of surfaces. Suitable rheology modifiers include guar gums, xanthan gum, celluloses, carbomers, and cross-linked polymers. Any kind of additive may be included in the antimicrobial composition, as long as it does not interfere with the action of the antimicrobial agent. Advantageously, the supramolecular host or guest chemical forms supramolecular structures with the antimicrobial agent. Such supramolecular structures or assemblies may take the form of, e.g., micelles, liposomes, nanostructures, or nanobubbles.

In various embodiments, the antimicrobial agent in the antimicrobial composition is adapted as a disinfectant (e.g., used on a surface to kill), antiseptic (e.g., used in or on an animal, such as a human), or biocide (e.g., used on a surface to inhibit or control growth). Preferably, as used herein, a disinfectant is used to kill microorganisms on a non-living surface, an antiseptic is applied topically to a mammalian body surface to kill microorganisms, and a biocide is used on a non-living surface to control or prevent growth of microorganisms. Citric acid, lactic acid ammonia, C₂ to C₁₆ alcohol compounds, chlorine and chlorine compounds, formaldehyde, glutaraldehyde, hydrogen peroxide, iodophors, ortho-phthalaldehyde, peracetic acid, phenolics, zinc, silver, copper and quaternary ammonium compounds are each suitable examples of an antimicrobial agent that can be adapted, formulated, and used as a disinfectant, an antiseptic, or a biocide. One of ordinary skill in the art recognizes that these types of disinfectants, antiseptics, or biocides are merely exemplary, and that this list is neither exclusive nor limiting to the compositions and methods described herein. In an exemplary embodiment, the antimicrobial agent includes one or more of peracetic acid, glutaraldehyde, benzalkonium chloride, sodium hypochlorite, tetrakis(hydroxymethyl)phosphonium sulphate, tetrakis(hydroxymethyl)phosphonium chloride, alkyl dimethyl benzyl ammonium chloride, didecyldimethylammonium chloride, or isopropyl alcohol, or a combination thereof. In one embodiment, the antimicrobial agent is a topical antiseptic that comprises one or more of citric acid, ammonia, a C₂ to C₁₆ alcohol compound, a chlorine or chlorine-based compound, formaldehyde, glutaraldehyde, hydrogen peroxide, an iodophor, a phenolic, zinc, silver, copper, quaternary ammonium compounds, or a combination thereof.

In certain embodiments, the antimicrobial agent is present in the antibacterial composition in an amount of about 5 percent to about 95 percent by weight of the antimicrobial composition, for example about 25 percent to about 75 percent by weight of the antimicrobial composition or about 30 percent to about 50 percent by weight of the antimicrobial composition.

In selecting suitable supramolecular host or guest chemical(s), (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with a solvent. A preferred solvent includes an aqueous solvent, such as water.

Host chemicals may include a charge, may have magnetic properties, or both. Host chemicals may be soluble or insoluble in the solvent system. If insoluble in the solvent, the particle size of the host chemical is typically greater than 100 nanometers, and the host chemical does not include nanoparticles or nanostructures. Suitable supramolecular host chemicals include cavitands, cryptands, rotaxanes, catenanes, minerals (e.g., clays, silica, or silicates), or any combination thereof.

Cavitands are container-shaped molecules that can engage in host-guest chemistry with guest molecules of a complementary shape and size. Examples of cavitands include cyclodextrins, calixarenes, pillarrenes, and cucurbiturils. Calixarenes are cyclic oligomers, which may be obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH₂]₃N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another but cannot be separated unless covalent bond breakage occurs.

Suitable supramolecular guest chemicals include cyanuric acid, minerals (e.g., clays, silica, or silicates), water, and melamine, and are preferably selected from cyanuric acid or melamine, or a combination thereof. Guest chemicals may have a charge, may have magnetic properties, or both. Guest chemicals may be soluble or insoluble in the solvent system. If the guest chemical is insoluble in the solvent, the particle size is generally greater than 100 nanometers, and the guest chemical is not in the form of nanoparticles or nanostructures.

The supramolecular host chemical or the supramolecular guest chemical is present in the antimicrobial composition in any suitable amount but is generally present in the antimicrobial composition in an amount of about 1 percent to about 90 percent by weight of the antimicrobial composition. In certain embodiments, the supramolecular host chemical or supramolecular guest chemical, or host and guest chemical combination, is present in an amount of about 10 percent to about 80 percent by weight of the antimicrobial composition, for example, 10 percent to about 50 percent by weight of the antimicrobial composition.

Any aqueous or non-aqueous solvent may be used, including for example water, an alcohol, a glycol, or an oil. Typically, an aqueous solvent is used, and water is used as a preferred aqueous solvent. The solvent is typically present in an amount that is at least sufficient to dissolve any solid components partially and preferably substantially in the antimicrobial composition. Water (or other polar solvent) is present in any suitable amount but is generally present in the antimicrobial composition in an amount of about 0.5 percent to about 80 percent by weight of the antimicrobial composition. In certain embodiments, water is present in an amount of about 5 percent to about 78 percent by weight of the antimicrobial composition, for example, 50 percent to about 75 percent by weight of the antimicrobial composition. In various embodiments, the solvent partially dissolves one more components of the antimicrobial composition. In some embodiments, the solvent is selected to at least substantially dissolve (e.g., dissolve at least 90%, preferably at least about 95%, and more preferably at least about 99% or 99.9%, of all the components) or completely dissolve all of the components of the antimicrobial composition.

The order of addition of the components of the antimicrobial composition can be important to obtain stable supramolecular structures or assemblies in the final mixture. The order of addition is typically: (1) an antimicrobial agent and (2) a supramolecular host chemical or a supramolecular guest chemical. Once these two components are fully mixed, supramolecular structures can be formed, and then the remaining components can be mixed into the formulation (i.e., solvent, adjuvant, buffering aids, etc.)

The antimicrobial compositions can be applied in any suitable manner, including by spraying the antimicrobial composition in an antimicrobially effective amount on a surface to be treated. In some embodiments, the surface is dosed at about 2 ppm to about 200 ppm of the antimicrobial composition. In several embodiments, the antimicrobial composition contacts the surface for a time sufficient to inhibit the growth of or reduce the concentration of microorganisms on the surface. For example, in certain embodiments, the contact time is about 30 minutes to about 120 hours. In a preferred embodiment, the contact time is no more than about 1 day, preferably no more than about 12 hours, and more preferably no more than about 1 hour. In another more preferred embodiment, the contact time is no more than about 15 minutes, preferably no more than about 5 minutes and more preferably no more than about 1 minute. In some embodiments, the growth of the one or more microorganisms is inhibited for at least 12 hours, preferably 24 hours, and more preferably 48 hours. In other embodiments, the antimicrobial composition is a disinfectant disposed on a surface for any of the contact times described above that is sufficient to kill one or more microorganisms. The microorganisms in all embodiments, unless otherwise specified, may be on the surface before application of the present antimicrobial compositions, or may come in contact with the surface after application of such compositions.

The antimicrobial compositions can also be added to another fluid in any suitable manner. In some embodiments, the antimicrobial compositions are used in oil and gas field operations, such as for water treatment. In one or more embodiments, the antimicrobial composition is present in the fluid in an amount of about 50 ppm to about 5000 ppm.

The following examples are illustrative of the compositions and methods discussed above and are not intended to be limiting.

### EXAMPLES

### Example 1

### Supramolecular Structure Synergy with Peracetic Acid

A formulation was prepared by using the commercially available ingredients and quantities listed in Table 1. The order of addition of the composition was important to obtain stable supramolecular structures in the final mixture. The order was as follows: the commercially available active chemical agent was added first and then the supramolecular host chemical was mixed with the active chemical agent.

TABLE 1
COMPOSITION 1

| Raw Material | Control (w/w) | Composition 1 (w/w) |
|---|---|---|
| Peracetic Acid | 50% | 50% |
| Deionized Water | 50% | |
| SymMax ™^{a} | | 50% |

^{a}SymMAX ™ supramolecular host or guest water mixture commercially available from Shotwell Hydrogenics, LLC or BPS Shotwell

Utilizing standardized microbiological protocols of culturing bacteria and biocide dose response methodologies, a systematic laboratory evaluation of the effectiveness of supramolecule structure chemistries on peracetic acid effects on bacterial growth and lifecycles was examined. This was completed by using certified Escherichia coli (E. coli) bacteria obtained from the Carolina Biological Supply, and master growth cultures were established in 1000.0 mL of trypticase soy broth agar and incubated at 35° C. for 48 hours. Biocide testing cultures were 50.0 mL sterile culture tubes where 50.0 mL of the E. coli master culture was aseptically transferred. Individual tubes for each test were dosed with the selected biocidal mixtures at 2 ppm and incubated at 35° C. for the duration of 24, 72, and 120 hours for assessment. Non-biocide treated 50.0 mL cultures were utilized as baseline “blanks” data for each allotted time period to determine percent reduction.

At the end of the incubation time periods, each biocide dosed tube was assayed utilizing the Bactiquant Mycometer (BQ) bacteria kit and protocols. Data results of the BQ tests were calculated using the Mycometer Excel spreadsheet tables and statistically evaluated for percent reduction of the growth curves of the E. coli. bacteria. Table 2 provides the results.

TABLE 2
RESULTS WITH PERACETIC ACID

| Dosage | Time | Control | Composition 1 | % |
|---|---|---|---|---|
| (ppm) | (hour) | (% reduction) | (% reduction) | Difference |
| 2 | 24 | 55.6 | 69 | 24.1 |
| 2 | 72 | 64.3 | 85 | 32.2 |
| 2 | 120 | 83 | 90 | 8.4 |

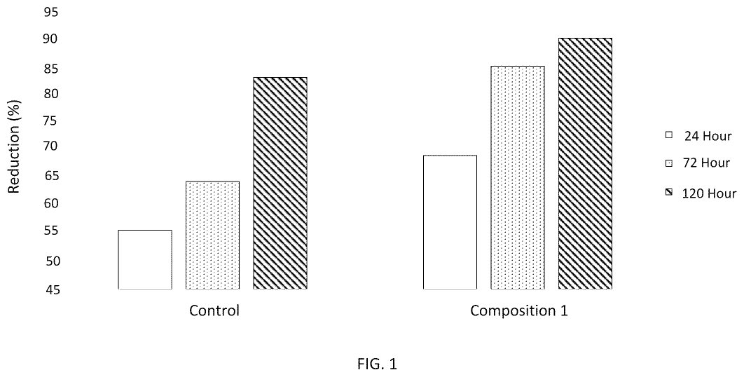

As seen in FIG. 1, Composition 1 increased the total amount of E. coli killed in the last time interval of 120 hours by more than 8%. However, the significant impact was in the time in which the E. coli bacteria was reduced. The 24-hour mark showed an increase of 24% bacterial reduction and 32% increase in bacterial reduction at the 72-hour mark.

### Example 2

### Supramolecular Structure Synergy with Glutaraldehyde

A formulation was prepared by using the commercially available ingredients and quantities listed in Table 3. The order of addition of the composition was important to obtain stable supramolecular structures in the final mixture. The order was as follows: the commercially available active chemical agent was added first and then the supramolecular host chemical was mixed with the active chemical agent.

TABLE 3
COMPOSITION 2

| Raw Material | Control (w/w) | Composition 2 (w/w) |
|---|---|---|
| Glutaraldehyde | 50% | 50% |
| Deionized Water | 50% | |
| SymMax ™^{a} | | 50% |

^{a}SymMAX ™ supramolecular host or guest water mixture commercially available from Shotwell Hydrogenics, LLC or BPS Shotwell

Utilizing standardized microbiological protocols of culturing bacteria and biocide dose response methodologies, a systematic laboratory evaluation of the effectiveness of supramolecule structure chemistries on glutaraldehyde effects on bacterial growth and lifecycles was examined. This was completed by using certified Escherichia coli (E. coli) bacteria obtained from the Carolina Biological Supply, and master growth cultures were established in 1000.0 mL trypticase soy broth agar and incubated at 35° C. for 48 hours. Biocide testing cultures were 50.0 mL sterile culture tubes where 50.0 mL of the E. coli master culture was aseptically transferred. Individual tubes for each test were dosed with the selected biocidal mixtures at 100 ppm and incubated at 35° C. for the duration of 24, 72, and 120 hours for assessment. Non-biocide treated 50.0 mL cultures were utilized as baseline “blanks” data for each allotted time period to determine percent reduction.

At the end of the incubation time periods, each biocide dosed tube was assayed utilizing the Bactiquant Mycometer (BQ) bacteria kit and protocols. Data results of the BQ tests were calculated using the Mycometer Excel spreadsheet tables and statistically evaluated for percentage reductions of the growth curves of the E. coli bacteria. Table 4 provides the results.

TABLE 4
RESULTS WITH GLUTARALDEHYDE

| Dosage | Time | Control (% | Composition 2 | % |
|---|---|---|---|---|
| (ppm) | (hour) | reduction) | (% reduction) | Difference |
| 100 | 24 | 48 | 49.6 | 3.3 |
| 100 | 72 | 60.6 | 80 | 32.0 |
| 100 | 120 | 83.4 | 86 | 3.1 |

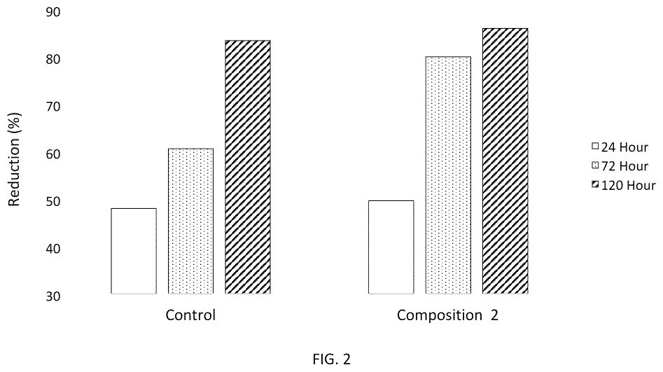

As seen in FIG. 2, Composition 2 increased the total amount of E. coli killed in the last time interval of 120 hours by more than 3%. However, the significant impact was on the time in which the E. coli bacteria was reduced. The 72-hour mark showed an increase of 32% bacterial reduction.

### Example 3

### Supramolecular Structure Synergy with Benzalkonium Chloride

A formulation was prepared by using the commercially available ingredients and quantities listed in Table 5. The order of addition of the composition was important to obtain stable supramolecular structures in the final mixture. The order was as follows: the commercially available active chemical agent was added first and then the supramolecular host chemical was mixed with the active chemical agent.

TABLE 5
COMPOSITION 3

| | Control | Composition |
|---|---|---|
| Raw Material | (w/w) | 3 (w/w) |
| Benzalkonium chloride | 50% | 50% |
| Deionized Water | 50% | |
| SymMax ™^{a} | | 50% |

^{a}SymMAX ™ supramolecular host or guest water mixture commercially available from Shotwell Hydrogenics, LLC or BPS Shotwell

Utilizing standardized microbiological protocols of culturing bacteria and biocide dose response methodologies, a systematic laboratory evaluation of the effectiveness of supramolecule structure chemistries on benzalkonium chloride effects on bacterial growth and lifecycles was examined. This was completed by using certified Escherichia coli (E. coli) bacteria obtained from the Carolina Biological Supply, and master growth cultures were established in 1000.0 mL trypticase soy broth agar and incubated at 35° C. for 48 hours. Biocide testing cultures were 50.0 mL sterile culture tubes where 50.0 mL of the E. coli master culture was aseptically transferred. Individual tubes for each test were dosed with the selected biocidal mixtures at 50 ppm and incubated at 35° C. for the duration of 24 and 48 hours for assessment. Non-biocide treated 50.0 mL cultures were utilized as baseline “blanks” data for each allotted time period to determine percent reduction.

At the end of the incubation time periods, each biocide dosed tube was assayed utilizing the Bactiquant Mycometer (BQ) bacteria kit and protocols. Data results of the BQ tests were calculated using the Mycometer Excel spreadsheet tables and statistically evaluated for percentage reductions of the growth curves of the E. coli bacteria. Table 6 provides the results.

TABLE 6
RESULTS WITH BENZALKONIUM CHLORIDE

| Dosage | Time | Control (% | Composition 3 | % |
|---|---|---|---|---|
| (ppm) | (hour) | reduction) | (% reduction) | Difference |
| 50 | 24 | 88 | 93 | 5.68 |
| 50 | 48 | 97.3 | 99 | 1.75 |

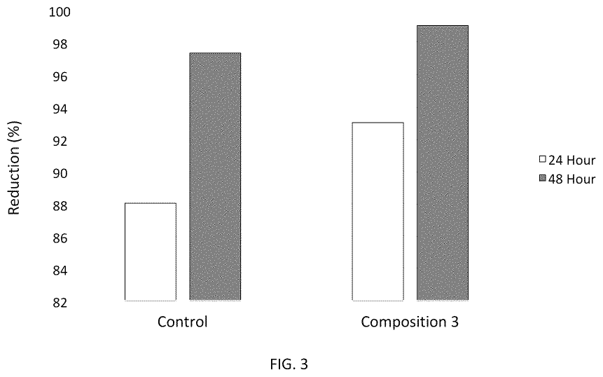

As seen in FIG. 3, Composition 3 increased the total amount of E. coli killed at the last time interval of 48 hours by more than 1%. However, the significant impact was on the time in which the E. coli bacteria was reduced. The 24-hour mark showed an increase of about 6% bacterial reduction.

### Example 4

### Supramolecular Structure Synergy with Sodium Hypochlorite

A formulation was prepared by using the commercially available ingredients and quantities listed in Table 7. The order of addition of the composition was important to obtain stable supramolecular structures in the final mixture. The order was as follows: the commercially available active chemical agent was added first and then the supramolecular host chemical was mixed with the active chemical agent.

TABLE 7
COMPOSITION 4

| | Control | Composition |
|---|---|---|
| Raw Material | (w/w) | 4 (w/w) |
| Sodium Hypochlorite | 50% | 50% |
| Deionized Water | 50% | |
| SymMax ™^{a} | | 50% |

^{a}SymMAX ™ supramolecular host or guest water mixture commercially available from Shotwell Hydrogenics, LLC or BPS Shotwell

Utilizing standardized microbiological protocols of culturing bacteria and biocide dose response methodologies, a systematic laboratory evaluation of the effectiveness of supramolecule structure chemistries on sodium hypochlorite effects on bacterial growth and lifecycles was examined. This was completed by using certified Escherichia coli (E. coli) bacteria obtained from the Carolina Biological Supply, and master growth cultures were established in 1000.0 mL trypticase soy broth agar and incubated at 35° C. for 48 hours. Biocide testing cultures were 50.0 mL sterile culture tubes where 50.0 mL of the E. coli master culture was aseptically transferred. Individual tubes for each test were dosed with the selected biocidal mixtures at 2 ppm and incubated at 35° C. for the duration of 5, 30, and 60 minutes for assessment. Non-biocide treated 50.0 mL cultures were utilized as baseline “blanks” data for each allotted time period to determine percent reduction.

At the end of the incubation time periods, each biocide dosed tube was assayed utilizing the Bactiquant Mycometer (BQ) bacteria kit and protocols. Data results of the BQ tests were calculated using the Mycometer Excel spreadsheet tables and statistically evaluated for percentage reductions of the growth curves of the E. coli bacteria. Table 8 provides the results.

TABLE 8
RESULTS WITH SODIUM HYPOCHLORITE

| Dosage | Time | Control (% | Composition 4 | % |
|---|---|---|---|---|
| (ppm) | (minutes) | reduction) | (% reduction) | Difference |
| 2 | 5 | 59.09 | 60.07 | 1.66 |
| 2 | 30 | 62.36 | 69.45 | 11.37 |
| 2 | 60 | 68.91 | 70.00 | 1.58 |

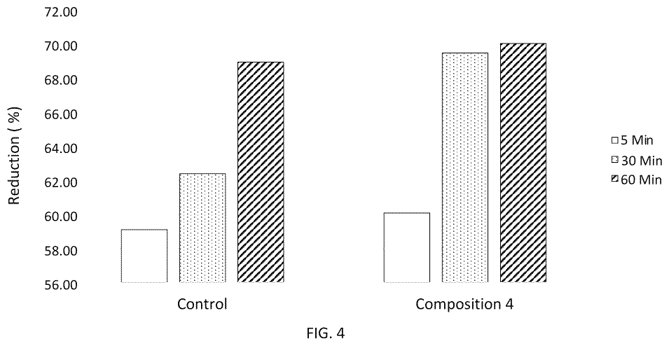

As seen in FIG. 4, Composition 4 increased the total amount of E. coli killed at the last time interval of 60 minutes by more than 1%. However, the significant impact was on the time in which the E. coli bacteria was reduced. The 30 minute mark showed an increase of 11% bacterial reduction.

### Example 5

### Supramolecular Structure Synergy with Tetrakis(hydroxymethyl)phosphonium Sulphate

A formulation was prepared by using the commercially available ingredients and quantities listed in Table 9. The order of addition of the composition was important to obtain stable supramolecular structures in the final mixture. The order was as follows: the commercially available active chemical agent was added first and then the supramolecular host chemical was mixed with the active chemical agent.

TABLE 9
COMPOSITION 5

| | Control | Composition |
|---|---|---|
| Raw Material | (w/w) | 5 (w/w) |
| Tetrakis(hydroxymethyl) | 50% | 50% |
| phosphonium sulphate | | |
| Deionized Water | 50% | 12.5% |
| SymMax ™^{a} | | 37.5% |

^{a}SymMAX ™ supramolecular host or guest water mixture commercially available from Shotwell Hydrogenics, LLC or BPS Shotwell

Utilizing standardized microbiological protocols of culturing bacteria and biocide dose response methodologies, a systematic laboratory evaluation of the effectiveness of supramolecule structure chemistries on tetrakis(hydroxymethyl)phosphonium sulphate effects on bacterial growth and lifecycles was examined. This was completed by using certified Escherichia coli (E. coli) bacteria obtained from the Carolina Biological Supply, and master growth cultures were established in 1000.0 mL trypticase soy broth agar and incubated at 35° C. for 48 hours. Biocide testing cultures were 50.0 mL sterile culture tubes where 50.0 mL of the E. coli master culture was aseptically transferred. Individual tubes for each test were dosed with the selected biocidal mixtures at 125 ppm and incubated at 35° C. for the duration of 4, 24, 48 and 120 hours for assessment. Non-biocide treated 50.0 mL cultures were utilized as baseline “blanks” data for each allotted time period to determine percent reduction.

At the end of the incubation time periods, each biocide dosed tube was assayed utilizing the Bactiquant Mycometer (BQ) bacteria kit and protocols. Data results of the BQ tests were calculated using the Mycometer Excel spreadsheet tables and statistically evaluated for percentage reductions of the growth curves of the E. coli bacteria.

TABLE 10
RESULTS WITH TETRAKIS(HYDROXYMETHYL)
PHOSPHONIUM SULPHATE

| Dosage | Time | Control | Composition 5 | % |
|---|---|---|---|---|
| (ppm) | (hour) | (% reduction) | (% reduction) | Difference |
| 125 | 4 | 54.20 | 56.00 | 3.32 |
| 125 | 24 | 68.50 | 81.00 | 18.25 |
| 125 | 48 | 89.80 | 93.10 | 3.67 |
| 125 | 120 | 94.70 | 97.40 | 2.85 |

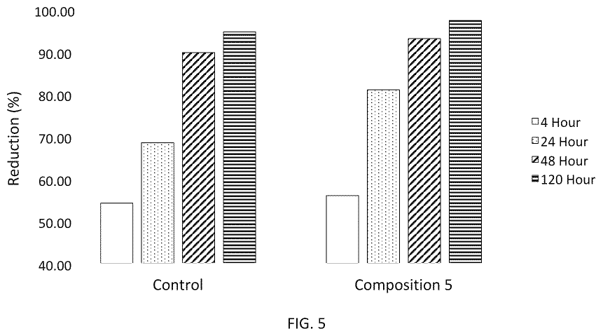

As seen in FIG. 5, Composition 5 increased the total amount of E. coli killed at the last time interval of 120 hours by more than 2%. However, the significant impact was on the time in which the E. coli bacteria was reduced. The 24-hour mark showed an increase of 18% bacterial reduction.

### Example 6

### Supramolecular Structure Synergy with Isopropyl Alcohol

A formulation was prepared by using the commercially available ingredients and quantities listed in Table 11. The order of addition of the composition was important to obtain stable supramolecular structures in the final mixture. The order was as follows: the commercially available active chemical agent was added first and then the supramolecular host chemical was mixed with the active chemical agent.

TABLE 11
COMPOSITION 6

| | Control | Composition |
|---|---|---|
| Raw Material | (w/w) | 6 (w/w) |
| Isopropyl Alcohol | 70% | 70% |
| Deionized Water | 30% | |
| SymMax ™^{a} | | 30% |

^{a}SymMAX ™ supramolecular host or guest water mixture commercially available from Shotwell Hydrogenics, LLC or BPS Shotwell

Utilizing standardized microbiological protocols of culturing bacteria and biocide dose response methodologies, a systematic laboratory evaluation of the effectiveness of supramolecule structure chemistries on isopropyl alcohol effects on bacterial growth and lifecycles was examined. This was completed by using certified Escherichia coli (E. coli) bacteria obtained from the Carolina Biological Supply and master growth cultures were established in 100.0 mL trypticase soy broth agar and incubated at 35° C. for 48 hours.

Borosilicate glass testing plates were autoclaved for use as the surface contamination specimens. Each plate was subsequently swabbed with a sterile foam swab that was dipped into the E. coli broth solution and allowed to air dry. The glass slides were treated with Composition 6 using a light coat misting, medium coat misting, and wipe disinfection steps. Light mist was setting the spray nozzle dispenser at the lowest setting on the spray bottle and standing two feet away from the plates and treating each set with Composition 6. Medium setting was performed in the same manner with a minor adjustment to the nozzle. Wipe mist was using the light mist technique then subsequently wiping the surface in a small circular motion with individual cloth towelettes.

The Mycometer Bactiquant (MB) Environmental Surface assaying kits, methods and software systems were utilized for the quantification of bacteria levels. Following the directed swab sampling protocols of the MB assay, each plate was analyzed for quantitative bacteria reduction levels of treatment exposure at time levels at 10, 30, 60, and 300 seconds. At the end of the incubation time periods, each biocide dosed plate was assayed utilizing the Bactiquant Mycometer (BQ) bacteria kit and protocols. Data results of the BQ tests were calculated using the Mycometer Excel spreadsheet tables and statistically evaluated for percentage reductions the growth curves of the E. coli bacteria. Tables 12-14 provides the results.

TABLE 12
RESULTS WITH ISOPROPYL ALCOHOL (LIGHT MIST)

| Time | | Composition 6 |
|---|---|---|
| (seconds) | Control (% reduction) | (% reduction) |
| 10 | 43.90 | 11.14 |
| 30 | 30.08 | 33.73 |
| 60 | 80.08 | 90.03 |
| 180 | 71.14 | 95.01 |
| | % difference for 180 seconds | 33.562 |

TABLE 13
RESULTS WITH ISOPROPYL ALCOHOL (MEDIUM MIST)

| Time | | Composition 6 |
|---|---|---|
| (seconds) | Control (% reduction) | (% reduction) |
| 10 | 14.52 | 28.48 |
| 30 | 55.03 | 61.30 |
| 60 | 51.60 | 66.56 |
| 180 | 80.18 | 92.88 |
| | % difference for 180 seconds | 15.83 |

TABLE 14
RESULTS WITH ISOPROPYL ALCOHOL (WIPE DOWN)

| Time | Control | Composition 6 |
|---|---|---|
| (seconds) | (% reduction) | (% reduction) |
| 10 | 97.73 | 96.76 |
| 30 | 97.63 | 96.44 |
| 60 | 98.52 | 98.38 |
| 180 | 97.33 | 97.09 |

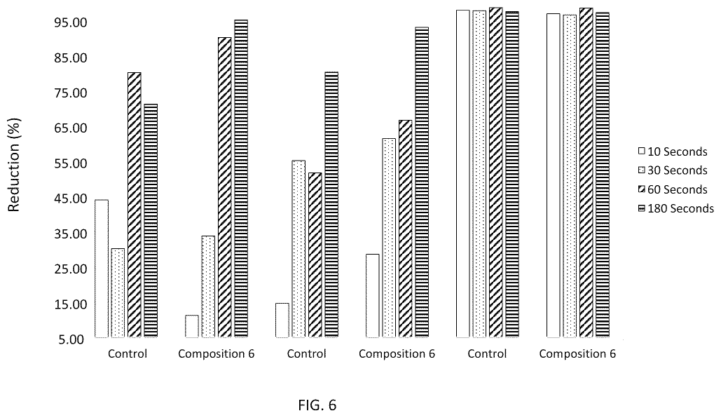

As seen in FIG. 6, with the light spray application more than 33% of bacteria was reduced compared to the control. Then in the medium spray application more than 15% of bacteria was reduced. In both applications, Composition 6 had quicker kill and higher reduction of bacteria reduced compared to control.

### Example 7

### Supramolecular Synergy for Bacterial Growth in Oil and Gas Systems

Utilizing a standardized NACE TM0194-2014 method, a systematic serial dilution evaluation of the effectiveness of supramolecular structure chemistries with common biocides on bacterial growth was examined for oil and gas applications. This was completed by utilizing Sulfate Reducing Bacteria (SRB) detection bottles and Acid Producing and General Heterotrophic Bacteria (APB) detection bottles supplied from VK Enterprises, (BB-TB and BB-PR catalog #, respectively).

To complete this study, a water source with anaerobic and aerobic bacteria was collected from an oil and gas production well. For this study one gallon of produced water was collected on site from an oil and gas producer in the Spraberry Trend of the Midland Basin. Once the water was collected, it was allowed to incubate at ambient conditions until testing was completed.

Formulations was prepared by using the commercially available ingredients and quantities listed in Tables 15-18. The order of addition of the composition was important to obtain stable supramolecular structures in the final mixture. The order was as follows: the commercially available active chemical agent was added first and then the supramolecular host chemical was mixed with the active chemical agent. Then the formulation was diluted with deionized water.

Once all formulations were completed, the controls and composition formulations were mixed with the water source at a 1:10 serial dilution into the appropriate SRB and APB bottles for testing at two different dosages—50 and 100 μl of composition. Four (4) bottles were created for each composition, where each bottle was serially diluted 10× so that the bacteria in the fourth bottle was diluted 10,000×. All test bottles were incubated at 30 ° C. for three weeks. At the end of week 2 and week 3, all bottles were examined for color change to indicate if the bacteria was still present. The number of bottles that indicated bacteria was noted, i.e., 4 bottles that turned color would have a score of 4 and 3 bottles that turned color would have a score of 3. Therefore, a score of 3 compared to a 4 was 10× better in performance. Every bottle that did not change color indicated a 10× increase in performance.

TABLE 15
COMPOSITIONS 7-8

| | Control | Composition | Composition |
|---|---|---|---|
| Raw Material | (w/w) | 7 (w/w) | 8 (w/w) |
| 75% w/w | 26.67% | 26.67% | 26.67% |
| Tetrakis(hydroxymethyl) | | | |
| phosphonium chloride | | | |
| SymMax ™^{a} | 0.00% | 5.00% | 7.50% |
| Deionized Water | 73.30% | 68.30% | 65.80% |

^{a}SymMAX ™ supramolecular host or guest water mixture commercially available from Shotwell Hydrogenics, LLC or BPS Shotwell

TABLE 16
COMPOSITIONS 9-10

| | Control | Composition | Composition |
|---|---|---|---|
| Raw Material | (w/w) | 9 (w/w) | 10 (w/w) |
| MBC 514^{a} | 50.00% | 50.00% | 50.00% |
| SymMax ™^{b} | 0.00% | 16.50% | 24.75% |
| Deionized Water | 50.00% | 33.50% | 25.00% |

^{a}MBC 514 biocide commercially available from Nashville Chemical (14% Glutaraldehyde and 2.5% Alkyl dimethyl benzyl ammonium chloride)
^{b}SymMAX ™ supramolecular host or guest water mixture commercially available from Shotwell Hydrogenics, LLC or BPS Shotwell

TABLE 17
COMPOSITIONS 11-12

| | Control | Composition | Composition |
|---|---|---|---|
| Raw Material | (w/w) | 11 (w/w) | 12 (w/w) |
| 50% w/w | 62.50% | 62.50% | 62.50% |
| Glutaraldehyde | | | |
| SymMax ™^{a} | 0.00% | 31.25% | 37.50% |
| Deionized Water | 37.50% | 6.25% | 0.00% |

^{a}SymMAX ™ supramolecular host or guest water mixture commercially available from Shotwell Hydrogenics, LLC or BPS Shotwell

TABLE 18
COMPOSITIONS 13-14

| | Control | Composition | Composition |
|---|---|---|---|
| Raw Material | (w/w) | 13 (w/w) | 14 (w/w) |
| 50% w/w | 50.00% | 50.00% | 50.00% |
| Didecyldimethyl- | | | |
| ammonium chloride | | | |
| SymMax ™^{a} | 0.00% | 6.25 | 43.75% |
| Deionized Water | 50.00% | 12.50% | 37.50% |

^{a}SymMAX ™ supramolecular host or guest water mixture commercially available from Shotwell Hydrogenics, LLC or BPS Shotwell

TABLE 19
RESULTS FOR COMPOSITIONS 7 AND 8

| | Tetrakis(hydroxymethyl)phosphonium | | | | | | | |
|---|---|---|---|---|---|---|---|---|
| | chloride | | | | | | | |
| | 50 μl Dosage | | | | 100 μl Dosage | | | |
| | 2 week | | 3 week | | 2 week | | 3 week | |
| | APB | SRB | APB | SRB | APB | SRB | APB | SRB |
| Negative Control | 4 | 3 | 4 | 4 | 4 | 3 | 4 | 4 |
| Control Composition | 3 | 2 | 3 | 2 | 3 | 2 | 3 | 2 |
| Composition 7 | 4 | 2 | 4 | 2 | 2 | 1 | 3 | 1 |
| Composition 8 | 3 | 2 | 3 | 2 | 2 | 1 | 2 | 1 |
| Order Magnitude Difference | −10 | 0 | −10 | 0 | 10 | 10 | 0 | 10 |
| to Control (7) | | | | | | | | |
| Order Magnitude Difference | 0 | 0 | 0 | 0 | 10 | 10 | 10 | 10 |
| to Control (8) | | | | | | | | |

As seen in Table 19, Compositions 7 and 8 increased the effectiveness of the active tetrakis(hydroxymethyl)phosphonium chloride, where one less bottle turned color, resulting in a 10× increase of performance for the higher dosages (100 μl) for both APB and SRB bottles.

TABLE 20
RESULTS FOR COMPOSITIONS 9 AND 10

| | MBC 514 | | | | | | | |
|---|---|---|---|---|---|---|---|---|
| | 50 μl Dosage | | | | 100 μl Dosage | | | |
| | 2 week | | 3 week | | 2 week | | 3 week | |
| | APB | SRB | APB | SRB | APB | SRB | APB | SRB |
| Negative Control | 4 | 3 | 4 | 4 | 4 | 3 | 4 | 4 |
| Control Composition | 2 | 2 | 2 | 2 | 1 | 1 | 1 | 2 |
| Composition 9 | 1 | 2 | 1 | 2 | 0 | 2 | 0 | 2 |
| Composition 10 | 0 | 2 | 0 | 2 | 0 | 2 | 0 | 2 |
| Order Magnitude Difference | 10 | 0 | 10 | 0 | 10 | −10 | 10 | 0 |
| to Control (9) | | | | | | | | |
| Order Magnitude Difference | 100 | 0 | 100 | 0 | 10 | −10 | 10 | 0 |
| to Control (10) | | | | | | | | |

As seen in Table 20, Compositions 9 and 10 increased the effectiveness of the active MBC 514, where one or two less bottles turned color, resulting in 10-100× increase of performance for both dosages for the APB bottles.

TABLE 21
RESULTS FOR COMPOSITIONS 11 AND 12

| | Gluteraldehyde | | | | | | | |
|---|---|---|---|---|---|---|---|---|
| | 50 μl Dosage | | | | 100 μl Dosage | | | |
| | 2 week | | 3 week | | 2 week | | 3 week | |
| | APB | SRB | APB | SRB | APB | SRB | APB | SRB |
| Negative Control | 4 | 3 | 4 | 4 | 4 | 3 | 4 | 4 |
| Control Composition | 4 | 2 | 4 | 2 | 3 | 2 | 3 | 2 |
| Composition 11 | 2 | 2 | 2 | 2 | 2 | 2 | 2 | 2 |
| Composition 12 | 3 | 2 | 3 | 2 | 3 | 2 | 3 | 2 |
| Order Magnitude Difference | 100 | 0 | 100 | 0 | 10 | 0 | 10 | 0 |
| to Control (11) | | | | | | | | |
| Order Magnitude Difference | 10 | 0 | 10 | 0 | 0 | 0 | 0 | 0 |
| to Control (12) | | | | | | | | |

As seen in Table 21, Compositions 11 and 12 increased the effectiveness of the active gluteraldehyde, where one or two less bottles turned color, resulting in 10 -100× increase of performance for both dosages for the APB bottles.

TABLE 22
RESULTS FOR COMPOSITION 13 AND 14

| | Didecyldimethylammonium chloride | | | | | | | |
|---|---|---|---|---|---|---|---|---|
| | 50 μl Dosage | | | | 100 μl Dosage | | | |
| | 2 week | | 3 week | | 2 week | | 3 week | |
| | APB | SRB | APB | SRB | APB | SRB | APB | SRB |
| Negative Control | 4 | 3 | 4 | 4 | 4 | 3 | 4 | 4 |
| Control Composition | 0 | 1 | 0 | 1 | 0 | 1 | 0 | 2 |
| Composition 13 | 0 | 1 | 0 | 1 | 0 | 0 | 0 | 0 |
| Composition 14 | 0 | 1 | 0 | 1 | 0 | 1 | 0 | 1 |
| Order Magnitude Difference | 0 | 0 | 0 | 0 | 0 | 10 | 0 | 100 |
| to Control (13) | | | | | | | | |
| Order Magnitude Difference | 0 | 0 | 0 | 0 | 0 | 0 | 0 | 10 |
| to Control (14) | | | | | | | | |

As seen in Table 22, Compositions 13 and 14 increased the effectiveness of the active didecyldimethylammonium chloride, where one or two less bottles turned color, resulting in 10-100× increase of performance for higher dosage for the SRB bottles.

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

1. An antimicrobial composition comprising:
an antimicrobial agent;
a supramolecular host chemical or a supramolecular guest chemical configured to engage in host-guest chemistry with the antimicrobial agent; and
a solvent.

2. The antimicrobial composition of claim 1, wherein the antimicrobial agent comprises a disinfectant, a topical antiseptic, or a biocide.

3. The antimicrobial composition of claim 1, wherein the antimicrobial agent comprises one or more of citric acid, ammonia, a C₂ to C₁₆ alcohol compound, a chlorine or chlorine-based compound, formaldehyde, glutaraldehyde, hydrogen peroxide, an iodophor, ortho-phthalaldehyde, peracetic acid, a phenolic, zinc, silver, copper, a quaternary ammonium compound, or a combination thereof.

4. The antimicrobial composition of claim 1, wherein the antimicrobial agent comprises one or more of peracetic acid, glutaraldehyde, benzalkonium chloride, sodium hypochlorite, tetrakis(hydroxymethyl)phosphonium sulphate, tetrakis(hydroxymethyl)phosphonium chloride, isopropyl alcohol, alkyl dimethyl benzyl ammonium chloride, didecyldimethylammonium chloride, or a combination thereof.

5. The antimicrobial composition of claim 1, which further comprises a pH buffer, a colorant, an adjuvant, a stabilizer, a rheology modifier, or a combination thereof.

6. The antimicrobial composition of claim 1, wherein the antimicrobial agent is present in an amount of about 5 percent to about 95 percent by weight of the composition.

7. The antimicrobial composition of claim 1, wherein the supramolecular host chemical or supramolecular guest chemical is present in an amount of about 1 percent to about 90 percent by weight of the composition.

8. The antimicrobial composition of claim 1, wherein the supramolecular host chemical is present and comprises a nanostructure having a charge, magnetic properties, or both.

9. The antimicrobial composition of claim 1, wherein the solvent comprises water.

10. The antimicrobial composition of claim 1, wherein the solvent is present in an amount of about 0.5 percent to about 80 percent by weight of the composition.

11. A method of preparing the antimicrobial composition of claim 1, wherein the method comprises:
forming a mixture of the antimicrobial agent and the supramolecular host chemical or the supramolecular guest chemical; and
adding the solvent to form the composition.

12. A method of inhibiting the growth of one or more microorganisms on a surface, which comprises:
applying an antimicrobial composition in an antimicrobially effective amount on the surface, the composition comprising:
an antimicrobial agent;
a supramolecular host chemical or a supramolecular guest chemical configured to engage in host-guest chemistry with the antimicrobial agent; and
a solvent.

13. The method of claim 12, wherein the antimicrobial agent is selected to comprise a disinfectant, a topical antiseptic, or a biocide.

14. The method of claim 12, wherein the antimicrobial composition is selected to comprise one or more of citric acid, ammonia, a C₂ to C₁₆ alcohol compound, a chlorine or chlorine-based compound, formaldehyde, glutaraldehyde, hydrogen peroxide, an iodophor, ortho-phthalaldehyde, peracetic acid, a phenolic, zinc, silver, copper, a quaternary ammonium compound, or a combination thereof.

15. The method of claim 12, wherein the antimicrobial composition is selected to comprise peracetic acid, glutaraldehyde, benzalkonium chloride, sodium hypochlorite, tetrakis(hydroxymethyl)phosphonium sulphate, tetrakis(hydroxymethyl)phosphonium chloride, isopropyl alcohol, alkyl dimethyl benzyl ammonium chloride, didecyldimethylammonium chloride, or a combination thereof.

16. The method of claim 12, wherein applying the antimicrobial composition comprises spraying the antimicrobial composition on or over the surface.

17. The method of claim 12, which further comprises contacting the antimicrobial composition with the surface for a time sufficient to inhibit the growth of the one or more microorganisms.

18. The method of claim 17, wherein the contact time is selected to be about 30 minutes to about 120 hours.

19. The method of claim 17, wherein the growth of the one or more microorganisms is inhibited for at least one day.

20. The method of any one of claim 12 to claim 19, wherein the antimicrobial agent is selected to be present in an amount of about 5 percent to 95 percent by weight of the composition.

21. The method of any one of claim 12 to claim 19, wherein the supramolecular host chemical or supramolecular guest chemical is selected to be present in an amount of about 1 percent to about 90 percent by weight of the composition.

22. The method of any one of claim 11 to claim 19, wherein the supramolecular host chemical is selected to be present and comprises a nanostructure having a charge, magnetic properties, or both.

23. A method of reducing a contact time of an antimicrobial agent with a surface to be disinfected, which comprises applying an antimicrobially effective amount of the antimicrobial composition of claim 1 to the surface.

24. A method of inhibiting the growth of one or more microorganisms in a fluid, which comprises:
adding an antimicrobial composition in an antimicrobially effective amount to the fluid, the composition comprising:
an antimicrobial agent;
a supramolecular host chemical or a supramolecular guest chemical configured to engage in host-guest chemistry with the antimicrobial agent; and
a solvent.

25. The method of claim 24, wherein the antimicrobial composition is selected to comprise peracetic acid, glutaraldehyde, benzalkonium chloride, sodium hypochlorite, tetrakis(hydroxymethyl)phosphonium sulphate, tetrakis(hydroxymethyl)phosphonium chloride, isopropyl alcohol, alkyl dimethyl benzyl ammonium chloride, didecyldimethylammonium chloride, or a combination thereof.
